(19) United States
(12) Patent Application Publication
(10) Pub. No.: US 2021/0261111 A1
(43) Pub. Date: Aug. 26, 2021

(54) METHOD FOR OPERATING A HYBRID POWERTRAIN WITH AN ELECTRIC MACHINE, AN INTERNAL COMBUSTION ENGINE AND A VARIABLE TRANSMISSION

(71) Applicant: Robert Bosch GmbH, Stuttgart (DE)

(72) Inventors: Lucas Hubertus Johannes Römers, Berg aan de Maas (NL); Arjen Brandsma, Tilburg (NL)

(21) Appl. No.: 17/255,387

(22) PCT Filed: Jun. 27, 2019
(86) PCT No.: PCT/EP2019/025201

§ 371 Date: Dec. 22, 2020

(30) Foreign Application Priority Data
Jun. 27, 2018 (NL) 1042915

(51) Int. Cl. B60W 20/10; B60W 10/06; B60K 6/365; B60K 6/48; B60W 10/08; B60W 10/101; B60K 6/543; B60W 30/18

(52) U.S. Cl. CPC B60W 20/10; B60W 10/06; B60K 6/365; B60K 6/48; B60K 2006/381; B60W 10/101; B60K 6/543; B60W 30/18027; B60W 10/08

(57) ABSTRACT

The invention relates to a hybrid powertrain in a motor vehicle with an internal combustion engine (1), an electric machine (2), a variable transmission (4) and one or more driven wheels (3). The transmission (4) includes at least a variator unit (9) for varying the output speed of the internal combustion engine (1) and a first differential gearing (5) with three rotary members (51, 54, 53) that are respectively drivingly connected to an output shaft (92) of the variator unit (9), a rotor shaft (21) of the electric machine (2) and a wheel shaft (31) of the driven wheels (3). The invention concerns a method for operating such a hybrid powertrain.

### BACKGROUND

The present disclosure relates to a method for operating a hybrid powertrain comprising an electric machine (EM) with a rotor shaft, an internal combustion engine (ICE) with a crank shaft, driven wheels and a variable transmission there between, in particular in or for motor vehicle, such as a passenger car. In the art several such hybrid powertrains have been proposed within a wide range of constructional complexities, each providing several operation modes, such as a battery-powered electric motor drive mode, a gasoline-powered ICE drive mode, a combined ICE and electric motor, i.e. hybrid drive mode, a brake energy recuperation or generator mode, etc.

The variable transmission includes a variator unit and a first differential gearing. The variator unit is provided for varying a speed ratio between an input shaft and an output shaft thereof, either stepwise or continuously within a range of speed ratios. Several types of variator unit are known in the art, whereof a common, continuous type is provided with two rotatable, variable pulleys, each associated with (i.e. mounted on and possibly partly formed integral with) a respective one of the said input and output shafts, and a drive belt or chain that is wrapped around the pulleys for drivingly connecting these. The first differential gearing is provided with three, relatively rotatable members that respectively drivingly connect to, i.e. rotate as a unit with either the ICE, the EM or the driven wheel. The first differential gearing serves to combine and/or distribute mechanical power between these three members during operation of the hybrid powertrain. In particular, a differential gearing balances the torque levels acting on its rotatable members, based on the rotational speed ratios provided there between. Such first differential gearing is well known in the art as well, most commonly in the form of an epicyclical differential or planetary gearing with a central sun gear that meshes with several individually rotatable planetary gears that are collectively born by a carrier that is rotatable coaxially with the sun gear, which planetary gears in turn mesh with a ring gear that is likewise coaxially rotatable with the sun gear. The carrier of the planetary gearing is drivingly connected to, i.e. rotates as a unit with the driven wheel, whereas the sun gear and the ring gear are respectively drivingly connected to, i.e. rotate as a unit with either the ICE or the EM respectively.

The variator unit is arranged between the ICE and the first differential gearing with its input shaft drivingly connected to, i.e. rotating as a unit with the ICE and with its output shaft drivingly connected to the first differential gearing.

It is noted that, the variable transmission is preferably provided with a final reduction gearing including a further differential gearing between the first differential gearing and the driven wheel, such that two driven wheels of the motor vehicle can be simultaneously driven at different rotational speeds when cornering. Moreover, a first clutch is preferably provided in the variable transmission to be able to mutually interlock a least two of the three rotatable members of the first differential gearing, making all three such members rotate as a unit and thus providing a fixed-ratio drive connection between the EM and the driven wheel. Further, a second clutch is preferably provided in the variable transmission to be able to selectively couple, i.e. to selectively drivingly connect, i.e. to couple the ICE and the first differential gearing, or to decouple these components from one another. The second clutch is preferably arranged between the variator unit and the first differential gearing, such that when the ICE is decoupled from the rest of the power train, the variator unit is decoupled as well.

In principle, the above powertrain can be operated in a fully electric drive mode, with the ICE switched-off and decoupled by the second clutch not being engaged, i.e. being open, and with the first clutch closed, i.e. being fully engaged to allow the EM to drive the driven wheels while drawing electric energy from a battery of the motor vehicle. If, however, an electric charge of the battery is or becomes too low for driving the motor vehicle as desired, the ICE is switched on and the second clutch is engaged to couple the ICE to the driven wheels to drive the vehicle and/or to the EM to charge the battery.

The present disclosure concerns a method for operating the hybrid powertrain realizing an acceleration of the driven wheels by the ICE from standstill when the vehicle is at rest. Vehicle acceleration by the ICE is for instance required when a state of charge of the battery is insufficient for driving the motor vehicle as desired, e.g. as demanded by the driver. Also, if the EM is relatively small, in particular in terms of its nominal torque level, i.e. if EM cannot on its own realise the desired vehicle acceleration, the ICE is switched on and the second clutch is engaged to support such acceleration.

Initially in this operating method, i.e. when the ICE is running (is switched on) while the vehicle is at rest, the carrier of the first differential gearing is blocked from rotating and the EM is driven in reverse direction by and relative to the ICE. In this operation mode of the hybrid powertrain, the EM generates electric power that can be used to charge the battery (and/or to power an electrical auxiliary of the motor vehicle such as an air conditioning compressor). Such battery-charging mode of the hybrid power train is described in the International patent application publication number WO 2014/0033668 A1.

To accelerate the driven wheels after unblocking the carrier, WO 2014/0033668 A1 teaches to gradually decrease the reverse rotational speed of the EM to zero, followed by the gradually increase of the forward rotational speed of the EM from zero. All the time during such forward acceleration of the EM, torque is generated on the carrier of the first differential gearing and the vehicle is accelerated. At some point in time, the speed of the rotatable member of the first differential gearing that is driven by the EM matches, i.e. synchronizes with the speed of the rotatable member thereof that is driven by the ICE. At such point in time, the first clutch is engaged to interlock the rotatable members of the first differential gearing. Further acceleration of the vehicle occurs by increasing the rotational speeds of the ICE and the EM simultaneously.

Although such known operating method functions well per se, the charging of the battery stops as soon as the EM changes from reverse rotation to forward rotation, i.e. such charging stops already in the initial stages of vehicle acceleration. After the first differential gearing is internally locked, charging can continue, but in between these two events electric power is drawn from the battery by the EM for the continued acceleration of the motor vehicle. If the state of charge of the battery is low, the resulting acceleration can be unsatisfactory. Also, the known operating method does not (i.e. cannot) make active use of the variator unit in synchronizing the speeds of the rotatable members of the first differential gearing. After all, in WO 2014/0033668 A1 the variator unit is located after the first differential gearing, i.e. between the first differential gearing and the driven wheels.

### SUMMARY

The present disclosure provides for a method for operating the hybrid powertrain with the variator unit located between the ICE and the first differential gearing, in particular for realizing the said acceleration of the driven wheels from standstill. The operating method according to the present disclosure comprises the steps of:
running the ICE at a first ICE (rotational) speed while driving the EM in reverse rotation at a first reverse EM (rotational) speed by the carrier of the first differential gearing being blocked from rotating,
unblocking the carrier of the first differential gearing, thus initiating the forward acceleration of the driven wheels,
increasing the ICE speed to a second ICE speed, higher than the first ICE speed, while continuing to drive the EM in reverse, thus continuing the forward acceleration of the driven wheels,
changing the EM speed from a reverse speed to a first forward EM speed, which first forward EM speed is determined to synchronize the (rotational) speed of the rotational members of the first differential gearing, and of
internally locking the first differential gearing.

In particular, by maintaining the reverse rotation of the EM during acceleration of the driven wheels, the charging of the battery favourably continues during such acceleration.

In another embodiment of the above operating method according to the present disclosure, the said step of increasing the ICE speed, while continuing to drive the EM in reverse, is preceded by or is carried out simultaneous with the step of:
decreasing the EM speed to a second reverse EM speed, lower than the first reverse EM speed.

In particular, by decreasing the speed of reverse rotation of the EM during acceleration of the driven wheels, a mechanical power taken up, i.e. consumed by the EM when exerting a torque to balance the ICE and carrier torques, favourably reduces, allowing for a faster acceleration of the vehicle by the same power generated by the ICE.

In another embodiment of the above operating method according to the present disclosure, the said step of increasing the ICE speed, while continuing to drive the EM in reverse, is followed or is carried out simultaneous with the step of:
changing the speed ratio of the variator unit to increase the rotational speed of its output shaft relative to the rotational speed of its input shaft, i.e. relative to the ICE speed.

In particular, by increasing the output speed of the variator unit the acceleration of the driven wheels favourably exceeds the increase of the ICE speed.

In another embodiment of either one of the above-described operating methods according to the present disclosure, the said synchronizing the rotational members of the first differential gearing, is carried out simultaneous with the step of:
changing the speed ratio of the variator unit to decrease the rotational speed of its output shaft relative to the rotational speed of its input shaft, i.e. relative to the ICE speed.

In particular, by decreasing the output speed of the variator unit, the change in EM speed required to synchronize the rotational members of the first differential gearing favourably reduces. Moreover, such variator speed ratio change is preferably determined to maintain an at least essentially constant torque on the carrier of the first differential gearing when synchronizing the rotatable members of the first differential gearing. In particular, by such constant carrier torque, synchronizing the rotational members of the first differential gearing is favourably hardly felt by the occupants of the motor vehicle.

In a first more detailed embodiment of the latter embodiment of the operating method according to the present disclosure, the ICE speed is maintained at least essentially constant while changing the speed ratio of the variator unit to decrease the rotational speed of its output shaft relative to the ICE speed. In particular, by such constant ICE speed, synchronizing the rotational members of the first differential gearing is favourably hardly audible to the occupants of the motor vehicle.

In a second more detailed embodiment of the said latter embodiment of the operating method according to the present disclosure, the ICE speed is decreased while changing the speed ratio of the variator unit to decrease the rotational speed of its output shaft relative to the ICE speed. In particular, by such decrease of the ICE speed, i.e. by the inertia of the ICE, an additional torque is generated on the output shaft of the variator unit that favourably assists the said synchronizing the rotational members of the first differential gearing. Hereby, synchronizing the rotational members of the first differential gearing is favourably hardly felt by the occupants of the motor vehicle.

In another embodiment of either one of the above-described operating methods according to the present disclosure, during the said synchronizing the rotational members of the first differential gearing, i.e. in the said step of changing the EM speed to a first forward EM speed, a torque exerted by the EM is maintained at least essentially constant. By such constant EM torque, synchronizing the rotational members of the first differential gearing is favourably hardly felt by the occupants of the motor vehicle. In this embodiment, the operation of the EM changes from generating electric power (i.e. battery-charging mode) while rotating in reverse, to consuming electric power (i.e. hybrid drive mode) while rotating forward. However, in this latter embodiment of the operating method according to the present disclosure and if further charging of the battery is required after the said step of internally locking the first differential gearing, the direction of the torque exerted by the EM can be reversed as well. Hereby, the operation of the EM changes from consuming electric power back to generating electric power, however, at a favourably increased efficiency of the power train due to the first differential gearing being internally locked.

### BRIEF DESCRIPTION OF THE DRAWINGS

The method for operating a hybrid powertrain according to the present disclosure is explained in more detail hereinafter by means of non-limiting, illustrative embodiments thereof and with reference to the drawing, in which:

FIG. 1 is a schematic representation of the functional arrangement of the main components of a specific type of hybrid powertrain provided with a variable transmission;

FIG. 2 is a graph illustrating the working principle of the first differential gearing of the hybrid powertrain of FIG. 1;

FIG. 3 illustrates the method for operating a hybrid powertrain of FIG. 1 in accordance with the present disclosure in a first graph; and

FIG. 4 illustrates the method for operating a hybrid powertrain of FIG. 1 in accordance with the present disclosure in a second graph.

### DETAILED DESCRIPTION

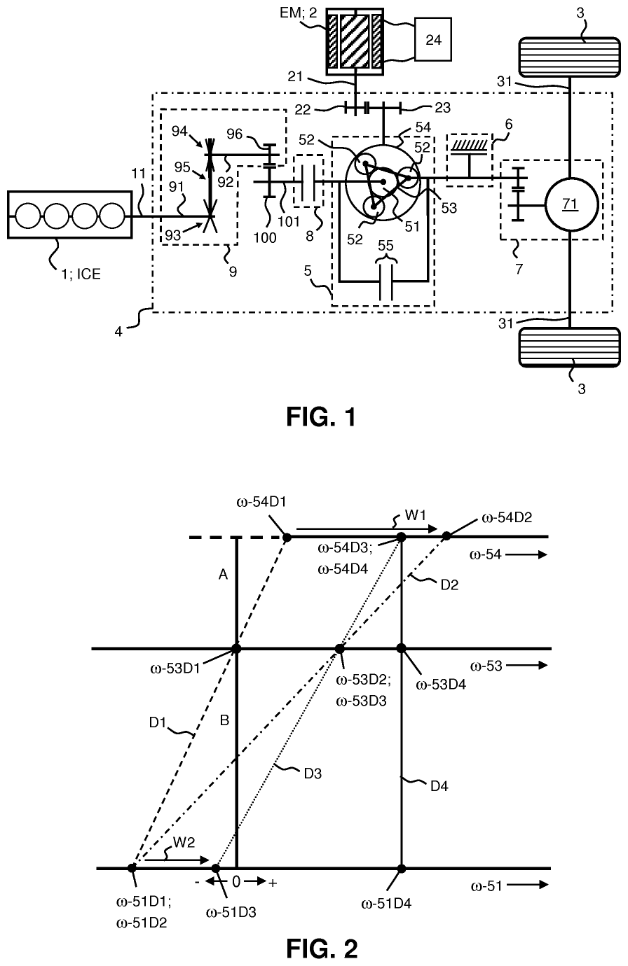

FIG. 1 shows a hybrid powertrain for a motor vehicle such as a passenger car. In such shown functional arrangement thereof, the hybrid powertrain comprises an internal combustion engine, i.e. ICE 1, with a crankshaft 11, an electric machine, i.e. EM 2, with a rotor shaft 21, two driven wheels 3 with wheel shafts 31 and with a variable transmission 4 there between. The known transmission 4 comprises a variator unit 9 and a first differential gearing 5. The variator unit 9 is provided with an input shaft 91 that is drivingly connected to, i.e. that rotates as a unit with the ICE 1 and with an output shaft 92. The variator unit 9 can vary a speed ratio between an input shaft 91 and an output shaft 92 thereof within a continuous range of speed ratios.

In the illustrative embodiment thereof in FIG. 1, the variator unit 9 is in the form of two rotatable, variable pulleys 93 and 94, each associated with (i.e. mounted on and is possibly partly formed integral with) a respective one of the said input and output shafts 91 and 92, and a drive belt or chain 95 that is wrapped around the pulleys 93 and 94 for drivingly connecting these.

The first differential gearing 5 is provided with three rotatable members 51, 54, 53 that are respectively drivingly connected to, i.e. rotate as a unit with the output shaft 92 of the variator unit 9, the rotor shaft 21 of the EM 2 and the wheel shafts 31 of the driven wheels 3. The first differential gearing 5 balances the torque levels acting on its rotatable members 51, 54, 53, based on the rotational speed ratios provided there between.

In the illustrative embodiment thereof in FIG. 1, the first differential gearing 5 is in the form of a planetary gearing 5 provided with a central sun gear 51 that is in meshing contact with one or more planet gears 52, which planet gears 52 are rotatably carried by a planet carrier 53 arranged coaxially rotatable with the sun gear 51, and with a ring gear 54 that is in meshing contact with the planet gears 52 and that is also arranged coaxially rotatable with the sun gear 51. A bridging clutch 55 is provided as part of planetary gearing 5, between the carrier 53 and sun gear 51 thereof. This bridging clutch 55 can be closed to internally lock the planetary gearing 5 such that the sun gear 51, the carrier 53 and the ring gear 54 thereof rotate as a unit. The sun gear 51 of the planetary gearing 5 is coupled to the crankshaft 11 of the ICE 1 via a second clutch 8, an auxiliary gear 100 on an auxiliary shaft 101, an output gear 96 on the output shaft 92 meshing with that auxiliary gear 100 and the variator unit 9 itself.

The second clutch 8 can be closed to drivingly connecting, i.e. to couple the ICE 1 and the variator unit 9 to the planetary gearing 5, or can be opened to decouple, i.e. to isolate the ICE 1 and the variator unit 9 from the rest of the hybrid powertrain. The ring gear 54 of the planetary gearing 5 is coupled to a pinion gear 22 on the rotor shaft 21 of the EM machine 2 via an idler gear 23 and the carrier 53 of the planetary gearing 5 is coupled to the driven wheels 3 via a final reduction gearing 7 including a further differential gearing 71. The final reduction gearing 7 provides a speed reduction between the ICE 1 and/or the EM 2 and the driven wheels 3, while the further differential gearing 71 thereof allows the two driven wheels 3 to each rotate at a respective rotational speed, as is common knowledge in the art.

The variable transmission 4 is provided with a brake or park lock 6 that can be engaged to lock, i.e. to prevent rotation of the final reduction gearing 7, in which case the ICE 1 can drive the EM 2, in particular to charge a battery 24 of the motor vehicle, or the EM 2 can drive the ICE 1, in particular to start it, without simultaneously driving and/or rotating the driven wheels 3 of the motor vehicle. When the park lock 6 is released, the EM 2 can drive the motor vehicle while drawing electric power from the battery 24, possibly supported by the ICE 1. Instead of the park lock 6 it is of course also possible to (automatically) engage the vehicle wheel brakes to charge the battery 24 without simultaneously driving the vehicle.

Further technical details of this particular type of hybrid powertrain, as well as the specific benefits and operations thereof, are described in the—not yet published—Dutch patent application NL-1042199.

The hybrid powertrain of FIG. 1 can be operated in several operation modes. For example, by opening the second clutch 8 while closing the bridging clutch 55, the EM 2 is coupled to the driven wheels 3 via the planetary gearing 5 and the variator unit 9, while the ICE 1 is decoupled from the planetary gearing 5. In this operation mode the motor vehicle is driven electrically by the EM 2 that also serves to recuperate mechanical energy during braking, storing it as electric energy in the battery 24. By closing the second clutch 8, while opening the bridging clutch 55, both the ICE 1 and the EM 2 are coupled to the driven wheels 3 via the planetary gearing 5, providing a parallel drive operation mode with some flexibility regarding the rotational speed of the output shaft 92 of the variator unit 9 and the rotational speed of the EM 2 in relation to the rational speed of the driven wheels 3. By closing botch the first clutch 8 and the bridging clutch 55, the output shaft 92 of the variator unit 9 and the EM 2 are still both coupled to the driven wheels 3, however, only at fixed speed ratio, thus providing a parallel, i.e. hybrid drive operation mode without flexibility regarding the said rotational speeds, but with less (dynamic) power loss.

A known method for driving off of the motor vehicle with the hybrid powertrain of FIG. 1 from standstill by means of the ICE 1, for example when the battery 24 is depleted, is described in WO 2014/0033668 A1. According to WO 2014/0033668 A1, the EM 2 initially rotates in reverse relative to the ICE 1 and the driven wheels 3 are accelerated by gradually decreasing the reverse rotational speed of the EM 2 to zero, followed by the gradually increase of the forward rotational speed of the EM 2 from zero. All the time during such forward acceleration of the EM 2, a traction force, i.e. a torque is generated on the carrier 53 of planetary gearing 5 and the vehicle is accelerated. At some point in time, the rotational speed of the ring gear 54 that is driven by the EM 2 matches, i.e. synchronizes with the rotational speed of the sun gear 51 that is driven by the ICE 1, at which point in time the planetary gearing 5 is locked by closing the bridging clutch 55. Further acceleration of the vehicle occurs by increasing the rotational speeds of both the ICE 1 and the EM 2.

According to the present disclosure and starting from the forward rotating ICE 1 and the backward rotating EM 2, the rotational speed of the ICE 1 is increased to accelerate the motor vehicle, in particular to accelerate the driven wheels 3 thereof via the planet carrier 53 of the planetary gearing 5. By this novel operating method, the driving off of the motor vehicle by the ICE 1 is enabled, while the EM 2 continues to generate electric power and can favourably charge the battery 24 even while driving off, by being driven in reverse. The backward rotational speed of the EM can, however, be decreased during driving off, to maximize the ICE power available for such driving off.

The method for operating the hybrid powertrain in accordance with the present disclosure is elucidated further with reference to FIG. 2. FIG. 2 is a diagram wherein the rotational speed of the sun gear ω-54, of the carrier ω-53 and of the ring gear ω-51 of the planetary gearing 5 are plotted on the three horizontal X-axes. The sun gear speed ω-54 that is equal—or at least proportional—to the rotational speed of the (crank shaft 11 of the) ICE 1 is plotted on the uppermost X-axis. The carrier speed ω-53 that is equal—or at least proportional—to the rotational speed of the driven wheels 3 is plotted on the middle X-axis. The ring gear speed ω-51 that is equal—or at least proportional—to the rotational speed of the (rotor shaft 21 of the) EM 2 is plotted on the lowermost X-axis. The vertical separation between these three X-axes reflects a speed ratio A between the carrier 53 and the sun gear 51 and between the ring gear 54 and the carrier 53, i.e. speed ratio B, respectively.

The dashed line D1 in FIG. 2 illustrates an initial operation mode of the hybrid powertrain. In this D1 operation mode, the sun gear 51 is rotating at a lowermost rotational speed ω-54D1 driven by the ICE 1, the driven wheels 3 are stopped such that the carrier 53 has a rational speed ω-53D1 of zero and the ring gear 54 is controlled to rotate backward by the EM 2 at a certain reverse, i.e. negative rotational speed ω-51D1. Preferably in this initial D1 operation mode, the EM 2 is additionally controlled to exert a forward, i.e. positive torque that acts against the said backward rotation thereof, whereby it generates electric power that is stored in the battery 24. In this latter case, a rotation of the carrier 53 and of the driven wheels 3 must be prevented by the automatic or manual application of a (wheel) brake such as the park lock 6.

Departing from such D1 operation mode, the brake of the driven wheels 3 is released and the speed of the (crank shaft 11 of the) ICE 1 is controlled to increase to accelerate the sun gear 51 to a higher speed ω-54D2 (as indicated in FIG. 2 by the arrow W1), while the speed of the (rotor shaft 21 of the) EM 2 is continued to be controlled to rotate the ring gear 54 backward at the same speed ω-51D2, whereby the driven wheels 3 are accelerated. This latter dynamic operation mode is illustrated in FIG. 2 by the dash-dotted line D2. In this D2 operation mode, the speed ω-53D2 of the carrier 3 is determined by the speed ω-54D2 of the sun gear 51 and the speed ω-51D2 of the ring gear 54, as well as by the speed ratios A, B of the planetary gearing 5. The driven wheels 3 may additionally be accelerated by controlling the EM 2 to decrease the backward rotation of the ring gear 54 (as indicated in FIG. 2 by the arrow W2) to a lower speed ω-51D3 of backward rotation, thus reducing the said electric power that is generated thereby. This latter dynamic operation mode is illustrated in FIG. 2 by the dotted line D3. Also in this latter D3 operation mode, the speed ω-53D2 of the carrier 3 is determined by the speed ω-54D2 of the sun gear 51 and the speed ω-51D2 of the ring gear 54, as well as by the speed ratios A, B of the planetary gearing 5.

Once the battery 24 is sufficiently charged or for continuing the acceleration of the drive wheels 3 also after the sun gear 51 has reached its maximum rotational speed ω-54D2 (as determined by the maximum ICE speed, the largest speed increase of the variator unit 9 and the gear ratio between the output gear 96 and the auxiliary gear 100), the speed of the EM 2 can be increased to a positive value, i.e. forward rotation, e.g. to ω-51D4, either to assist the ICE 1 in driving the driven wheels 3, to solely drive the driven wheels 3 (with the ICE 1 switched off), or to continue charging the battery 24 by generating a negative torque that acts against the said forward rotation of the EM. This latter hybrid operation mode is illustrated in FIG. 2 by the solid line D4. In this D4 operation mode, preferably, the said bridging clutch 55 is closed to internally lock the planetary gearing 5 for reducing power losses. Possibly also, the said second clutch 8 is opened in the D4 operation mode to decouple and switch off the ICE 1. In this latter respect, it is noted that the ICE 1 can be (re-)started by the inertia of the hybrid powertrain by (again) closing this second clutch 8, such that a separate starter motor for the ICE 1 is not needed. Hereto, preferably, this second clutch 8 is a friction clutch with a relatively low slipping torque capacity, such as a cone-clutch.

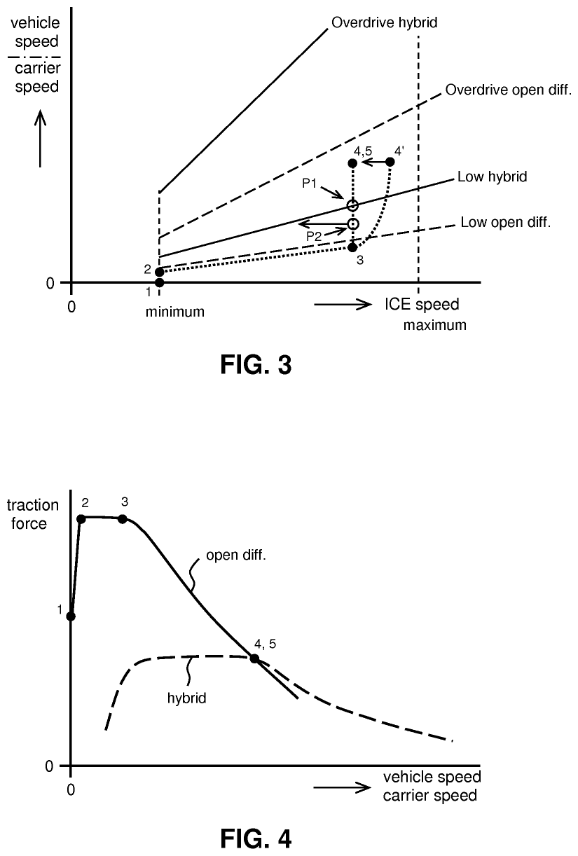

The method for operating the hybrid powertrain in accordance with the present disclosure is elucidated further with reference to FIG. 3. FIG. 3 is a graph that relates the rotational speed of the ICE 1 on the horizontal X-axis to the rotational speed ω-53 of the carrier 53 of the planetary gearing 5 on the vertical Y-axis, which latter speed ω-53 is linearly proportional to the speed of the motor vehicle. In FIG. 3, the solid lines that are marked “Low hybrid” and “Overdrive hybrid” define the upper and lower bounds of an area in the graph that can be reached by controlling the ICE speed to a value from a minimum to a maximum possible rotational speed and by controlling the variator unit speed ratio to a value from Low, i.e. largest deceleration of the ICE speed, to Overdrive, i.e. largest acceleration of the ICE speed, when the planetary gearing 5 is internally locked, i.e. when the bridging clutch 55 is engaged/closed (i.e. hybrid drive mode). Similarly, the long-dashed lines that are marked “Low open diff.” and “Overdrive open diff.” define the upper and lower bounds of an area in the graph that can be reached by controlling the ICE speed and the variator unit speed ratio, when the planetary gearing 5 is unlocked, i.e. when the bridging clutch 55 is open (i.e. open differential/diff. mode), while the rotational speed ω-51 of the ring gear 54 is zero.

The initial operating point of the hybrid powertrain provided under the operating method according to the present disclosure is marked “1” in FIG. 3. In this operating point 1, the ICE 1 rotates forward at a certain ICE speed (here: equal to minimum ICE speed), the EM 2 rotates backward at a certain, negative EM speed and the carrier 53 of the planetary gearing 5 is at rest. Next, in operating point 2, the negative EM speed has been decreased, but is still negative, without changing the ICE speed, resulting in a certain, forward vehicle speed. Next, in operating point 3, the ICE speed has been increased, resulting in an increased forward vehicle speed. Next, in operating point 4, the variator unit speed ratio has been changed from Low towards Overdrive without changing the ICE speed, resulting in a further increase in the forward vehicle speed. Next, in operating point 5, EM speed has been changed from negative to positive, the variator unit speed ratio has been changed towards Low without changing the ICE speed, to synchronize the planetary gearing 5, in particular the rotatable members 51, 53, 54 thereof. In operating point 5, the planetary gearing 5 is locked and further acceleration of the motor vehicle by the ICE 1 can occur within the “Low hybrid”−“Overdrive hybrid” area in the graph of FIG. 3.

The circle marked P1 in FIG. 3 illustrates the lowest vehicle speed in relation to a given ICE speed at which the planetary gearing 5 can be synchronised and locked by changing the variator unit speed ratio to Low without also having to decrease the ICE speed, as would, for instance, be necessary when synchronizing the planetary gearing 5 at P2. Nonetheless, a small decrease in ICE speed can even be advantageous when synchronizing the planetary gearing 5, because it helps the EM 2 to change its rotation direction and accelerate. For example, when departing from operating point 3, operating point 4′ can be set alternative to operating point 4 by changing the variator unit speed ratio from Low towards Overdrive, while simultaneously increasing the ICE speed. Now, when synchronizing the planetary gearing 5, i.e. when operating the powertrain to change from operating point 4′ to operating point 5, the ICE speed decreases somewhat, which helps to speed up the EM 2 as required.

The method for operating the hybrid powertrain in accordance with the present disclosure is elucidated further with reference to FIG. 4. FIG. 4 is a graph that relates the rotational speed ω-53 of the carrier 53 of the planetary gearing 5 on the horizontal X-axis to the traction force, i.e. torque acting on the carrier 53 on the vertical Y-axis, which traction force is linearly proportional to the traction force at the driven wheels 3 (at least by approximation). The operating point 1-4 indicated in FIG. 4 correspond to those indicated in FIG. 3. FIG. 4 illustrates that between operating points 1 and 2 the traction force increases, because the power taken up by the EM 2 decreases. Between operating points 2 and 3 the traction force is essentially constant (at least by approximation and assuming the ICE 1 has a flat torque curve). Between operating points 3 and 4 the traction force decreases, because of the changing speed ratio between the ICE 1 and the planetary gearing 5 provided by the variator unit 9. FIG. 4 also illustrates that with an open planetary gearing 5 (open diff. mode) and from at certain variator speed ratio towards Overdrive, the traction force matches or nearly matches the traction force that is available in the hybrid mode at the same vehicle speed. The planetary gearing 5 is preferably synchronized between operating points 4 and 5 in such range of matching traction force.

Bracketed references in the claims do not limit the scope thereof, but merely provide a non-limiting example of a respective feature. Separately claimed features can be applied separately in a given product or a given process, as the case may be, but can also be applied simultaneously therein in any combination of two or more of such features.

The invention(s) represented by the present disclosure is (are) not limited to the embodiments and/or the examples that are explicitly mentioned herein, but also encompass(es) straightforward amendments, modifications and practical applications thereof, in particular those that lie within reach of the person skilled in the relevant art.

1. A method for operating a hybrid powertrain in a motor vehicle comprising an internal combustion engine (1), an electric machine (2), a driven wheel (3) and a variable transmission (4) there between, which variable transmission (4) is provided with a first differential gearing (5) with three, relatively rotatable members (51, 53, 54) that are respectively intended to be drivingly connected to one of the internal combustion engine (1), the electric machine (2) and the driven wheel (3) and which variable transmission (4) is further provided with a variator unit (9) capable of varying a speed ratio between an input shaft (91) and an output shaft (92), whereof the input shaft (91) is intended to be driven by the internal combustion engine (1) and whereof the output shaft (92) is intended to drive the driven wheel (3) via the first differential gearing (5),
comprising the steps of:
running the internal combustion engine (1) at a first engine speed, while blocking the driven wheels (3) from rotating and while driving the electric machine (2) in reverse rotation at a first reverse machine speed,
unblocking the drive wheels (3) and initiating the forward acceleration of the motor vehicle, characterized in that the method further comprises the sequential steps of:
increasing the speed of the internal combustion engine (1) from the first engine speed to a second engine speed and continuing the forward acceleration of the motor vehicle (3), while continuing to drive the electric machine (2) in reverse rotation,
changing the rotation of the electric machine from reverse rotation to forward rotation at a first forward machine speed, which first forward machine speed is determined to synchronize the speed of the rotational members (51, 53, 54) of the first differential gearing (5), and of
blocking the relatively rotatable members (51, 53, 54) of the first differential gearing (5) from rotating relative to one another.

2. The method for operating the hybrid powertrain according to claim 1, characterized in that, at least initially during the step of increasing the speed of the internal combustion engine (1), while continuing to drive the electric machine (2) in reverse rotation, the machine speed is kept constant at the first reverse machine speed.

3. The method for operating the hybrid powertrain according to claim 1, characterized in that preceding or at some time interval during the step of increasing the speed of the internal combustion engine (1), while continuing to drive the electric machine (2) in reverse rotation, changing the speed of reverse rotation of the electric machine (2) from the first reverse machine speed to a second reverse machine speed.

4. The method for operating the hybrid powertrain according to claim 1, characterized in that preceding or at some time interval during the step of increasing the speed of the internal combustion engine (1), while continuing to drive the electric machine (2) in reverse rotation, the speed ratio of the variator unit (9) is changed to increase a speed of its output shaft (92) relative to a speed of its input shaft (91).

5. The method for operating the hybrid powertrain according to claim 1, characterized in that during the synchronizing of the rotational members (51, 53, 54) of the first differential gearing (5), the speed ratio of the variator unit (9) is varied to decrease a speed of its output shaft (92) relative to a speed of its input shaft (91).

6. The method for operating the hybrid powertrain according to claim 5, characterized in that during the synchronizing of the rotational members (51, 53, 54) of the first differential gearing (5), the speed ratio of the variator unit (9) is varied to keep the engine speed essentially constant.

7. The method for operating the hybrid powertrain according to claim 5, characterized in that during the synchronizing of the rotational members (51, 53, 54) of the first differential gearing (5), the speed ratio of the variator unit (9) is varied to decrease the engine speed.

8. The method for operating the hybrid powertrain according to claim 1, characterized in that during the synchronizing of the rotational members (51, 53, 54) of the first differential gearing (5), a torque that is exerted by the electric machine EM on the variable transmission (4) is kept essentially constant.

9. The method for operating the hybrid powertrain according to claim 1, characterized in that, the first differential gearing (5) is embodied as a planetary gearing (5) provided with a central sun gear (51) that is in meshing contact with one or more planet gears (52), which planet gears (52) are rotatably carried by a planet carrier (53) arranged coaxially rotatable with the sun gear (51), and with a ring gear (54) that is in meshing contact with the planet gears (52) and that is also arranged coaxially rotatable with the sun gear (51).

10. The method for operating the hybrid powertrain according to claim 9, characterized in that, the internal combustion engine (1) is drivingly connected to the planetary gearing (5) via the sun gear (51), the electric machine (2) is drivingly connected to the planetary gearing (5) via the ring gear (54) and the driven wheel (3) is drivingly connected to the planetary gearing (5) via the planet carrier (53).

11. The method for operating the hybrid powertrain according to claim 9, characterized in that the planetary gearing (5) is further provided with a bridging clutch (55) that is engaged to block the relatively rotatable members (51, 53, 54) of the planetary gearing (5) from rotating relative to one another after the step of synchronizing the relatively rotatable members (51, 53, 54).
